(19) United States
(12) Patent Application Publication
(10) Pub. No.: US 2007/0264503 A1
(43) Pub. Date: Nov. 15, 2007

(54) Polymers comprising polyhydric alcohols, medical devices modified with same, and method of making

(76) Inventors: Yu-Chin Lai, Pittsford, NY (US); Weihong Lang, Penfield, NY (US); Wenyan Yan, Fairport, NY (US)

Correspondence Address: Bausch & Lomb Incorporated, One Bausch & Lomb Place, Rochester, NY, 14604-2701, US

(21) Appl. No.: 11/432,173

(22) Filed: May 11, 2006

(51) Int. Cl. B32B 27/30; B32B 27/00; B32B 9/04

(52) U.S. Cl. 428/411.1; 428/522; 428/500; 428/447; 526/317.1; 526/319

(57) ABSTRACT

A medical device having an increased surface hydrophilicity comprises a coating polymer comprising units of a polymerizable hydrophilic compound, such as a polymerizable polyhydric alcohol. The coating polymer can be applied to a medical device comprising a hydrogel material. The medical device can have a reduced dehydration rate compared to a device that is devoid of such a coating polymer and/or provide increased comfort to a user.

### BACKGROUND OF THE INVENTION

The present invention relates to polymers comprising polyhydric alcohols, medical devices having surfaces modified with such polymers, and method for making such devices. In particular, the present invention relates to ophthalmic devices having surfaces modified for increased hydrophilicity and/or decreased dehydration rates.

Advances in the chemistry of materials for medical devices have increased the comfort for their extended use in a body environment. Furthermore, extended use of medical devices, such as ophthalmic lenses, has become increasingly favored due to the availability of soft contact lenses having high oxygen permeability (e.g., exhibiting high Dk values greater than 80) and/or high water content. Such lenses are increasingly made of silicone-containing materials. Although these materials have some desirable properties for ophthalmic applications, they tend to have relatively hydrophobic surfaces that have a high affinity for lipids. Accumulation of these materials can interfere with the clarity of the lens and the comfort of the wearer. Hydrophilic surfaces tend to limit the adsorption onto and absorption into ophthalmic lenses of tear lipids and proteins and allow the lenses to move relatively freely on the eye, thus providing increased comfort to the wearer.

A known method for modifying the surface hydrophilicity of a relatively hydrophobic ophthalmic device, such as a contact lens, is through the use of a plasma treatment. Plasma treatment techniques are disclosed, for example, in PCT Publications WO 96/31792 to Nicholson et al., WO 99/57581 to Chabrececk et al., and WO 94/06485 to Chatelier et al. In the Chabrececk et al. application, photoinitiator molecules are covalently bound to the surface of the article after the article has been subjected to a plasma treatment which provides the surface with functional groups. A layer of polymerizable macromonomer is then coated onto the modified surface and heat or radiation is applied to graft polymerize the macromonomer to form the hydrophilic surface. Plasma treatment processes, however, require a significant capital investment in plasma processing equipment. Moreover, plasma treatments take place in a vacuum and, thus, require that the substrate be mostly dry before exposure to the plasma. Thus, substrates, such as contact lenses, that are wet from prior hydration or extraction processes must be dried, thereby further adding to both the capital and production costs. As a result of the conditions necessary for plasma treatment, the incorporation of a plasma treatment process into an automated production process is extremely difficult.

Other methods of permanently altering the surface properties of polymeric biomaterials, such as contact lenses, have been developed. Some of these techniques include Langmuir-Blodgett deposition, controlled spin casting, chemisorptions, and vapor deposition. Examples of Langmuir-Blodgett layer systems are disclosed in U.S. Pat. Nos. 4,941,997; 4,973,429; and 5,068,318. Like plasma treatments, these techniques are not cost-effective methods that may easily be incorporated into automated production processes for making biomedical devices such as contact lenses.

Another method of producing a hydrophilic surface is discussed in U.S. Pat. No. 6,926,965. The method is carried out in a layer-by-layer (LbL) fashion, which involves consecutively dipping a substrate into oppositely charged polymeric materials until a coating of a desired thickness is formed.

These prior-art methods are tedious and often require a pretreatment of the surfaces. As a result, the manufacturing costs for the finished devices can be high.

Therefore, there is a continued need to provide medical devices, such as ophthalmic lenses, that have improved hydrophilic surfaces and are compatible with physiological environment, and improved methods for making them.

### SUMMARY OF THE INVENTION

In general, the present invention provides medical devices that have hydrophilic surfaces and/or reduced dehydration rates and methods for making these devices.

In one aspect, the medical devices of the present invention provide higher level of performance quality and/or comfort to the users.

In one aspect, the present invention provides a medical device having a hydrophilic polymer coating on a surface of the medical device.

In another aspect, the hydrophilic polymer coating is attached to the surface of the medical device.

In still another aspect, the coating comprises a coating polymer covalently attached to the surface of the medical device.

In yet another aspect, the coating polymer is attached to the surface of the medical device through an intermediate polymer that has functional groups capable of interacting with functional groups on the surface of the medical device and functional groups of the coating polymer.

In still a further aspect, the coating polymer comprises moieties that are ionizable at a physiological condition.

In still another aspect, the medical devices are ophthalmic devices.

In yet another aspect, the medical devices are contact lenses.

In still another aspect, the medical devices have reduced dehydration rates compared to those that do not have a polymeric coating of the present invention.

In a further aspect, the present invention provides a method of making a medical device that has a hydrophilic surface. The method comprises: (a) providing the medical device having at least a medical-device surface functional group; (b) providing a polymer having at least a hydrophilic moiety and at least a polymer functional group capable of interacting with said at least a medical-device surface functional group; and (c) contacting the medical device with the polymer at a condition sufficient to produce the medical device having an increased surface hydrophilicity.

In still a further aspect, the medical device produced by such a method has an increased surface lubricity and/or reduced dehydration rate.

Other features and advantages of the present invention will become apparent from the following detailed description and claims.

### DETAILED DESCRIPTION OF THE INVENTION

In general, the present invention provides medical devices that have hydrophilic surfaces and/or reduced dehydration rate and methods for making these devices.

In one aspect, the medical devices have increased surface lubricity.

In another aspect, the medical devices of the present invention provide higher level of performance quality and/or comfort to the users due to their hydrophilic or lubricious surfaces. In one embodiment, the medical devices are contact lenses, such as extended-wear contact lenses. Hydrophilic surfaces of such contact lenses substantially prevent or limit the adsorption of tear lipids and proteins on, and their eventual absorption into, the contact lenses, thus preserving the clarity of the contact lenses, and in turn their performance quality. Their lubricious surfaces also allow them to move more freely on the corneal and thus provide a higher level of comfort to the wearer.

In still another aspect, the present invention provides a medical device having a hydrophilic polymer coating that is attached to a surface of the medical device. In one embodiment, the hydrophilic polymer coating comprises a plurality of hydrophilic moieties, which may be the same or different.

In another embodiment, the hydrophilic polymer coating provides a plurality of charges at a physiological condition. The polymer coating can be attached to a surface of the medical device directly or indirectly through strong interactions such as covalent bonds or ionic interactions. In other embodiments, the polymer coating can interact with a surface of the medical device through weaker interactions, such as by hydrogen bonding, physical adsorption, or chemisorption at the surface of the medical device.

In one aspect, the coating polymer comprises a plurality of moieties that support charges at a physiological condition, such as a condition found in an environment or on a surface of a human organ. The phrase “support a charge” means generally carrying a charge by any mechanism. In another aspect, such physiological condition is found in a human ocular environment, such as a condition on the human cornea. The plurality of moieties can provide negative or positive charges at a physiological condition. The coating polymer also can have a combination of some negatively charged moieties and some other positively charged moieties. In another embodiment, the coating polymer also can have moieties that are non-neutral at a physiological condition due to the presence of atoms that have unshared electrons, such as oxygen or nitrogen.

In another aspect, the coating polymer comprises monomeric units selected from the group consisting of polymerizable polyhydric alcohols, polymerizable carboxylic acids, derivatives thereof, combinations thereof, and mixtures thereof.

In still another aspect, the polymerizable polyhydric alcohols are glycerol (meth)acrylate, erythritol (meth)acrylate, xylitol (meth)acrylate, sorbitol (meth)acrylate, derivatives thereof, combinations thereof, or mixtures thereof. The term “(meth)acrylate” means methacrylate or acrylate. In one embodiment, the (meth)acrylate is mono(meth)acrylate. In another embodiment, di(meth)acrylate or a mixture of mono(meth)acrylate and di(meth)acrylate may be used.

In yet another aspect, the polymerizable polyhydric alcohols comprise a material other than polymerizable poly(alkylene glycol) (or poly(oxyalkylene)) and derivatives thereof. In one embodiment, the polymerizable polyhydric alcohols are other than polymerizable poly(ethylene glycol) or polymerizable poly(propylene glycol).

In yet another aspect, the polymerizable carboxylic acids are (meth)acrylic acid, alkenoic acids, derivatives thereof, combinations thereof, or mixtures thereof.

In one embodiment, the coating polymer comprises monomeric units of a polymerizable polyhydric alcohol and monomeric units of a polymerizable carboxylic acid. In another embodiment, the coating polymer comprises monomeric units of glycerol (meth)acrylate and monomeric units of (meth)acrylic acid. In still another embodiment, the number of units of the polymerizable polyhydric alcohol is greater than the number of units of monomeric units of the polymerizable carboxylic acid. In still another embodiment, the number of units of the polymerizable polyhydric alcohol is fewer than the number of units of monomeric units of the polymerizable carboxylic acid,

In one aspect, the carboxyl moieties of the carboxylic acids can provide negative charges at a physiological condition. In one embodiment, the carboxylic acids are selected from alkenoic acids comprising 4 to and including 10 carbon atoms. In another embodiment, the alkenoic acids are selected from the group consisting of maleic acid, fumaric acid, itaconic acid, derivatives thereof (such as maleic anhydride, fumaric anhydride, itaconic anhydride), combinations thereof, and mixtures thereof. The term “carboxylic acids” also includes compounds that are capable of being converted into carboxylic acids, such as, for example, vinyldimethyloxozalone (“VDMO”).

In still another embodiment, the coating polymer is attached to the surface of the medical device through an intermediate compound or linking compound, such as an intermediate polymer (or also herein sometimes called “linking polymer”) that has functional groups capable of interacting with functional groups on the surface of the medical device and functional groups of the coating polymer. Thus, the intermediate polymer acts to couple the coating polymer to the surface of the medical device. For example, the intermediate polymer can comprise the glycidyl functional group, which is capable of forming bonds with a variety of other functional groups, such as hydroxyl, mercapto, carboxyl, or amino groups. Alternatively, the intermediate polymer can comprise the amino group, which is capable of forming bonds with functional groups such as carboxylic or glycidyl groups.

In yet another embodiment, the intermediate polymer comprises units of glycidyl methacrylate or glycidyl acrylate. In another embodiment, the intermediate polymer comprises poly(N,N-dimethylacrylamide-co-glycidyl methacrylate) (“poly(DMA-co-GMA)”).

In a further embodiment, the medical device has a polymer coating consisting or consisting essentially of units of methacrylic acid or acrylic acid and units of glycerol methacrylate. In an alternate embodiment, the coating polymer is attached to the surface of the medical device through an intermediate polymer consisting or consisting essentially of poly(DMA-co-GMA).

In yet a further embodiment, the medical device has a polymer coating consisting or consisting essentially of units of methacrylic acid or acrylic acid and units of xylitol methacrylate (such as, for example, xylitol 1-methacrylate or xylitol 3-methacrylate). In an alternate embodiment, the coating polymer is attached to the surface of the medical device through an intermediate polymer consisting or consisting essentially of poly(DMA-co-GMA). In still another embodiment, the medical device has a polymer coating consisting or consisting essentially of units of methacrylic acid or acrylic acid and units of sorbitol methacrylate.

Polyhydric alcohol (meth)acrylates (e.g., glycerol (meth)acrylate, erythritol (meth)acrylate, xylitol (meth)acrylate, or sorbitol (meth)acrylate) can be prepared by reacting (meth)acryloyl chloride with the desired polyhydric alcohol using a mole ratio of 1:1 or less ((meth)acryloyl chloride:polyhydric alcohol) in the presence of an acid scavenger such as triethylamine (“TEA”). The desired polyhydric alcohol (meth)acrylate may be separated and further purified using chromatography, such as HPLC.

In one aspect, the medical device comprises a polymeric material and the functional groups on the surface thereof are parts of units of the polymeric material. For example, hydrogel polymers of contact lens typically comprise hydrophilic monomeric units, such as 2-hydroxyethyl methacrylate, which provides hydroxyl surface groups. Alternatively, a hydrogel polymer comprising acrylic acid or methacrylic acid units has carboxyl surface groups.

In one embodiment of the present invention, wherein a contact lens comprises hydrophilic monomeric units of acrylic acid or methacrylic acid, the intermediate polymer comprises poly(glycidyl methacrylate) (“poly(GMA)”), and the coating polymer comprises a copolymer of methacrylic acid and glycerol methacrylate (also known as glyceryl methacrylate), the surface modified contact lens is produced according to Scheme 1, wherein a, b, c, a₁, a₂, c₁, and c₂ are positive integers, a=a₁+a₂, and c=c₁+c₂. The integers b and c can be chosen such that the coating polymer and the intermediate polymer can be easily formulated in a solvent for application to the contact lens. In one embodiment, b, b₁, and b₂ can range from about 10 to about 10000, or from about 50 to 5000, or from about 50 to about 2000, or from about 50 to about 1000; and a can range from about 10 to about 1000, or from about 50 to 500, or from about 50 to about 200, or from about 50 to about 100.

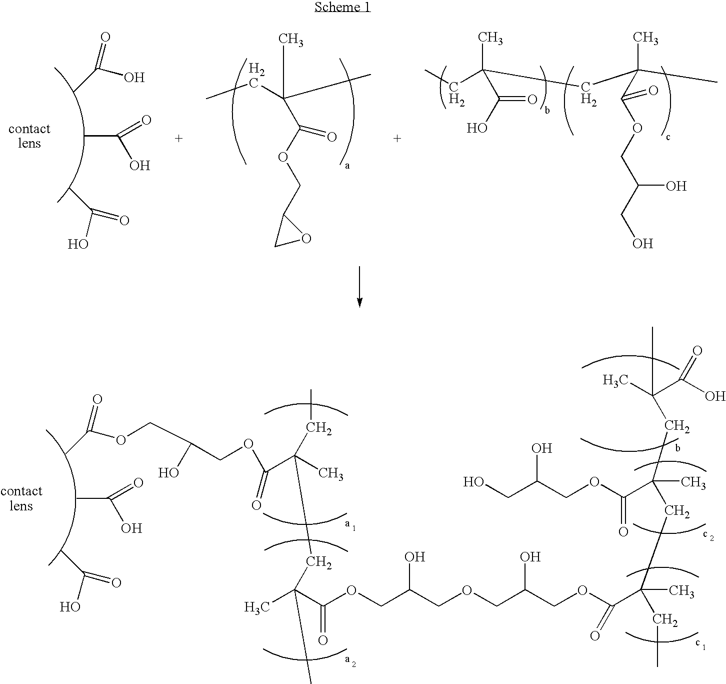

In another embodiment of the present invention, wherein a contact lens comprises hydrophilic monomeric units of acrylic acid or methacrylic acid, the intermediate polymer comprises poly(DMA-co-GMA), and the coating polymer comprises copolymer of acrylic acid and glycerol methacrylate, the surface modified contact lens is produced according to Scheme 2, wherein u, v, x, y, b, c, c₁, and c₂ are positive integers, and c=c₁+c₂. The integers u, v, x, y, b, and c can be chosen such that the coating polymer and the intermediate polymer can be easily formulated in a solvent for application to the contact lens. In one embodiment, u, v, x, y, b, c, c₁, and c₂ can range from about 10 to about 10000, or from about 50 to 5000, or from about 50 to about 2000, or from about 50 to about 1000. In another embodiment, x and y can range from about 10 to about 1000, or from about 50 to 500, or from about 50 to about 200, or from about 50 to about 100.

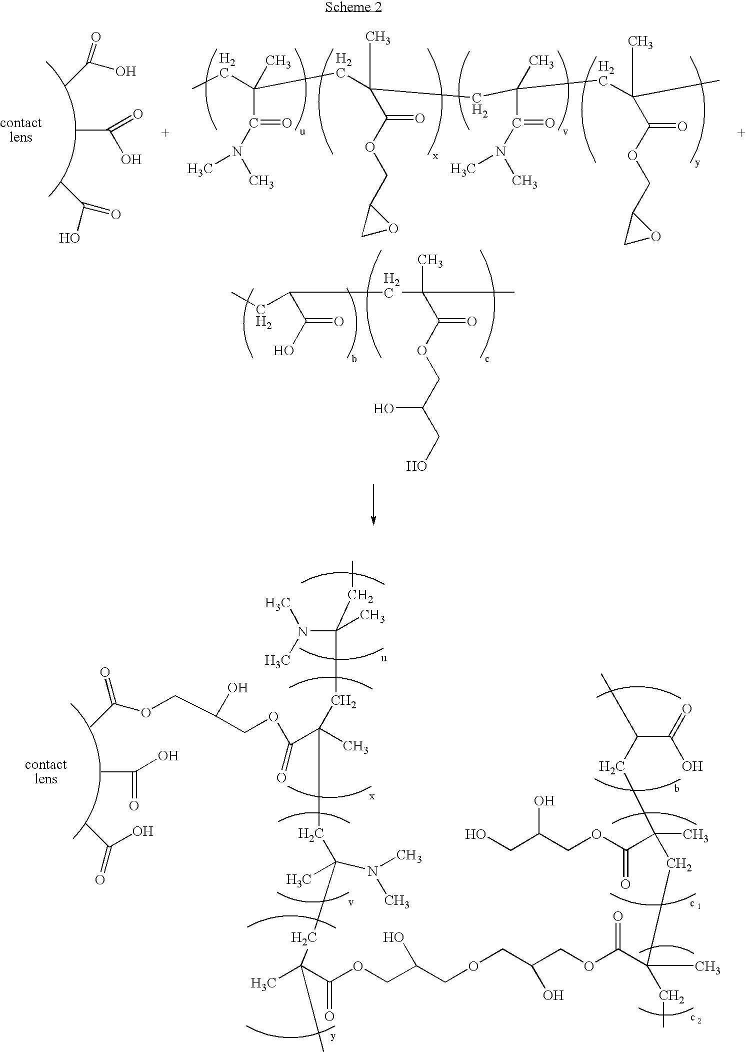

In another embodiment of the present invention, wherein a contact lens comprises hydrophilic monomeric units of 2-hydroxyethylmethacrylate (“HEMA”), the intermediate polymer comprises poly(DMA-co-GMA), and the coating polymer comprises units of methacrylic acid and glycerol methacrylate, the surface-modified contact lens is produced according to Scheme 3, wherein u, v, x, y, b, c, c₁, and c₂ are positive integers, and c=c₁+c₂. The integers u, v, x, y, b, c, c₁, and c₂ can be chosen such that the coating polymer and the intermediate polymer can be easily formulated in a solvent for application to the contact lens. In one embodiment, u, v, x, y, b, c, c₁, and c₂ can range from about 10 to about 10000, or from about 50 to 5000, or from about 50 to about 2000, or from about 50 to about 1000. In another embodiment, x an y can range from about 10 to about 1000, or from about 50 to 500, or from about 50 to about 200, or from about 50 to about 100

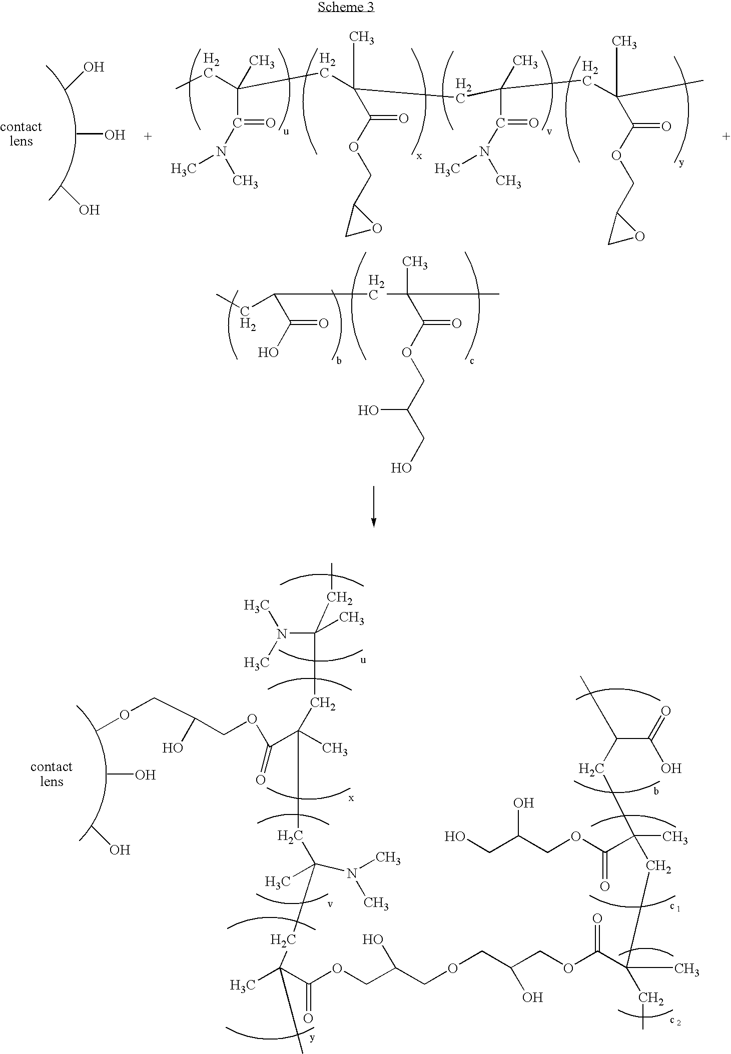

In another embodiment of the present invention, wherein a contact lens comprises hydrophilic monomeric units of glycidylmethacrylate (“GMA”), and the coating polymer comprises units of acrylic acid and glycerol methacrylate, the surface-modified contact lens is produced according to Scheme 4, wherein b, c, c₁, and c₂ are positive integers, and c=c₁+c₂. In one embodiment, b, c, c₁, and C₂ can range from about 10 to about 10000, or from about 50 to 5000, or from about 50 to about 2000, or from about 50 to about 1000.

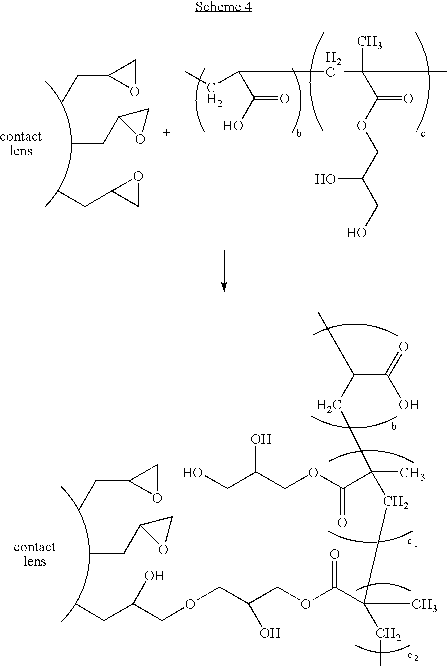

In another embodiment of the present invention, wherein a contact lens comprises hydrophilic monomeric units of 2-aminoethyl methacrylate, and the coating polymer comprises units of methacrylic acid and glycerol methacrylate, the surface-modified contact lens is produced according to Scheme 5, wherein b, c, b₁, and b₂ are positive integers, and b=b₁+b₂. In one embodiment, b, c, b₁, and b₂ can range from about 10 to about 10000, or from about 50 to 5000, or from about 50 to about 2000, or from about 50 to about 1000.

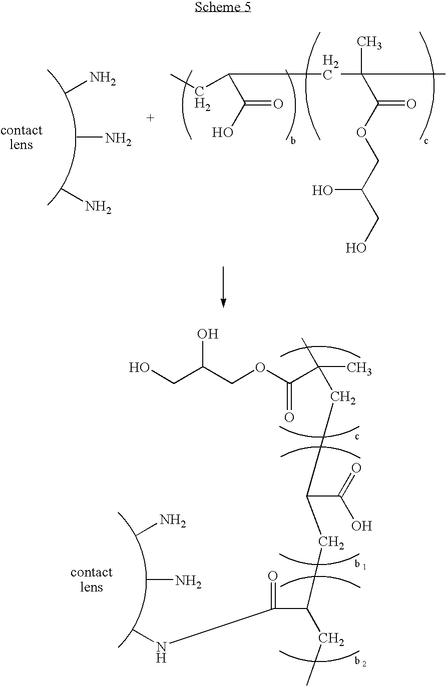

In one aspect, the surface treatment of the medical device can be carried out, for example, at about room temperature or under autoclave condition. The medical device is immersed in a solution comprising the intermediate polymer and the coating polymer. Thus, in one aspect, the medical device comes into contact with the intermediate polymer and the coating polymer substantially simultaneously. In another aspect, the medical device is immersed in a solution comprising the intermediate polymer. Then, after some elapsed time, the coating polymer is added to the solution in which the medical device is still immersed. In one embodiment of the method of treatment, the solution is aqueous.

In another aspect, the surface of the medical device can be treated with a plasma discharge or corona discharge to increase the population of reactive surface groups. The type of gas introduced into the treatment chamber is selected to provide the desired type of reactive surface groups. For example, hydroxyl surface groups can be produced with a treatment chamber atmosphere comprising water vapor or alcohols. Carboxyl surface groups can be generated with a treatment chamber comprising oxygen or air or another oxygen-containing gas. Ammonia or amines in a treatment chamber atmosphere can generate amino surface groups. Sulfur-containing gases, such as organic mercaptans or hydrogen sulfide, can generate the mercaptan group on the surface. A combination of any of the foregoing gases also can be used in the treatment chamber. Methods and apparatuses for surface treatment by plasma discharge are disclosed in, for example, U.S. Pat. Nos. 6,550,915 and 6,794,456, which are incorporated herein in their entirety by reference. Such a step of treatment with a discharge can be carried out before the treated device is contacted with a medium containing the coating polymer.

Medical devices comprising a wide variety of polymeric materials, including hydrogel and non-hydrogel materials, can be made to have hydrophilic surfaces. In general, non-hydrogel materials are hydrophobic polymeric materials that do not contain water in their equilibrium state. Typical non-hydrogel materials comprise silicone acrylics, such as those formed from bulky silicone monomer (e.g., tris(trimethylsiloxy)silylpropyl methacrylate, commonly known as “TRIS” monomer), methacrylate end-capped poly(dimethylsiloxane) prepolymer, or silicones having fluoroalkyl side groups. On the other hand, hydrogel materials comprise hydrated, cross-linked polymeric systems containing water in an equilibrium state. Hydrogel materials contain about 5 weight percent water or more (up to, for example, about 80 weight percent). Non-limiting examples of materials suitable for the manufacture of medical devices, such as contact lenses, are herein disclosed.

Hydrogel materials for medical devices, such as contact lenses, can comprise a hydrophilic monomer, such as, HEMA, methacrylic acid (“MM”), acrylic acid (“M”), methacrylamide, acrylamide, N,N′-dimethylmethacrylamide, or N,N′-dimethylacrylamide; copolymers thereof; hydrophilic prepolymers, such as poly(alkylene oxide) having varying chain length, functionalized with polymerizable groups; and/or silicone hydrogels comprising siloxane-containing monomeric units and at least one of the aforementioned hydrophilic monomers and/or prepolymers. Hydrogel materials also can comprise a cyclic lactam, such as N-vinyl-2-pyrrolidone (“NVP”), or derivatives thereof. Still further examples are the hydrophilic vinyl carbonate or vinyl carbamate monomers disclosed in U.S. Pat. No. 5,070,215, and the hydrophilic oxazolone monomers disclosed in U.S. Pat. No. 4,910,277. Other suitable hydrophilic monomers will be apparent to one skilled in the art.

Silicone hydrogels generally have water content greater than about 5 weight percent and more commonly between about 10 to about 80 weight percent. Such materials are usually prepared by polymerizing a mixture containing at least one siloxane-containing monomer and at least one hydrophilic monomer. Typically, either the siloxane-containing monomer or the hydrophilic monomer functions as a crosslinking agent (a crosslinking agent or crosslinker being defined as a monomer having multiple polymerizable functionalities) or a separate crosslinker may be employed. Applicable siloxane-containing monomeric units for use in the formation of silicone hydrogels are known in the art and numerous examples are provided, for example, in U.S. Pat. Nos. 4,136,250; 4,153,641; 4,740,533; 5,034,461; 5,070,215; 5,260,000; 5,310,779; and 5,358,995.

Examples of applicable siloxane-containing monomeric units include bulky polysiloxanylalkyl (meth)acrylic monomers. The term “(meth)acrylic” means methacrylic or acrylic, depending on whether the term “meth” is present or absent. An example of bulky polysiloxanylalkyl (meth)acrylic monomers are represented by the following Formula I: 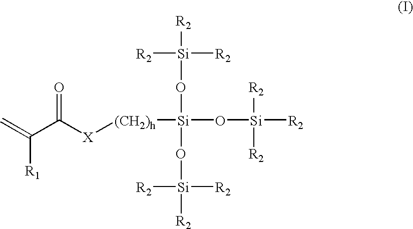
wherein X denotes —O— or —NR—; each R₁ independently denotes hydrogen or methyl; each R₂ independently denotes a lower alkyl radical, phenyl radical or a group represented by 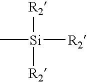
wherein each R′₂ independently denotes a lower alkyl, fluoroalkyl, or phenyl radical; and h is 1 to 10. The term “lower alkyl” means an alkyl radical having 1, 2, 3, 4, 5, 6, 7, 8, 9, or 10 carbon atoms, such as methyl, ethyl, propyl, butyl, isobutyl, pentyl, isopentyl, or hexyl radical.

A suitable bulky monomer is methacryloxypropyltris(trimethyl-siloxy)silane or tris(trimethylsiloxy)silylpropyl methacrylate (“TRIS”).

Another class of representative silicon-containing monomers includes silicone-containing vinyl carbonate or vinyl carbamate monomers such as: 1,3-bis{4-vinyloxycarbonyloxy)but-1-yl}tetramethyldisiloxane; 3-(trimethylsilyl)propyl vinyl carbonate; 3-(vinyloxycarbonylthio)propyl-{tris(trimethylsiloxy)silane}; 3-{tris(trimethylsiloxy)silyl}propyl vinyl carbamate; 3-{tris(trimethylsiloxy)silyl}propyl allyl carbamate; 3-{tris(trimethylsiloxy)silyl}propyl vinyl carbonate; t-butyldimethylsiloxyethyl vinyl carbonate; trimethylsilylethyl vinyl carbonate; and trimethylsilylmethyl vinyl carbonate.

Another class of representative silicon-containing monomers includes silicone-containing vinyl carbonate or vinyl carbamate monomers such as: 1,3-bis{4-vinyloxycarbonyloxy)but-1-yl}tetramethyl-disiloxane; 3-(trimethylsilyl)propyl vinyl carbonate; 3-(vinyloxycarbonylthio)propyl-{tris(trimethylsiloxy)silane}; 3-{tris(tri-methylsiloxy)silyl}propyl vinyl carbamate; 3-{tris(trimethylsiloxy)silyl}propyl allyl carbamate; 3-{tris(trimethylsiloxy)silyl}propyl vinyl carbonate; t-butyidimethylsiloxyethyl vinyl carbonate; trimethylsilylethyl vinyl carbonate; and trimethylsilylmethyl vinyl carbonate.

An example of silicon-containing vinyl carbonate or vinyl carbamate monomers are represented by Formula II: 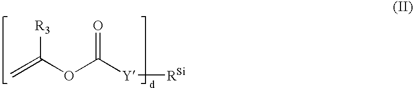
wherein:
Y′ denotes —O—, —S— or —NH—;
R^{Si} denotes a silicon-containing organic radical;
R₃ denotes hydrogen or methyl; and
d is 1, 2, 3 or 4.

Suitable silicon-containing organic radicals R^{Si} include the following: 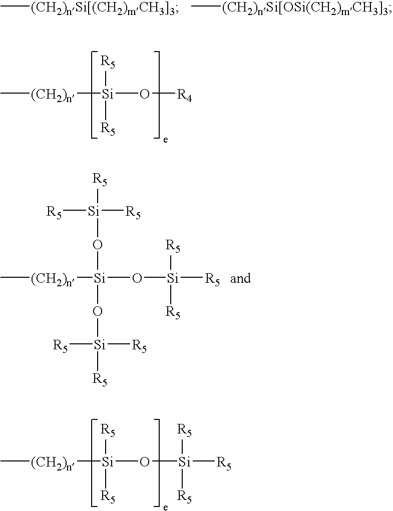
wherein
R₄ denotes 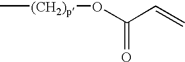
   wherein p′ is from 1 to and including 6;
R₅ denotes an alkyl radical or a fluoroalkyl radical having from 1 to and including 6 carbon atoms;

1e is 1 to 200; n′ is 1, 2, 3 or 4; and m′ is 0, 1, 2, 3, 4 or 5.

An example of a particular species within Formula II is represented by Formula III.

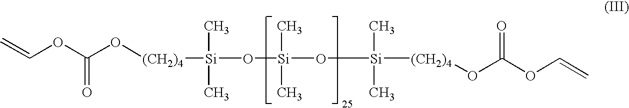

Another class of silicon-containing monomer includes polyurethane-polysiloxane macromonomers (also sometimes referred to as prepolymers), which may have hard-soft-hard blocks like traditional urethane elastomers. They may be end-capped with a hydrophilic monomer such as HEMA. Examples of such silicone urethanes are disclosed in a variety or publications, including Lai, Yu-Chin, “The Role of Bulky Polysiloxanylalkyl Methacryates in Polyurethane-Polysiloxane Hydrogels, ” Journal of Applied Polymer Science, Vol. 60, 1193-1199 (1996). PCT Published Application No. WO 96/31792 discloses examples of such monomers, which disclosure is hereby incorporated by reference in its entirety. Further examples of silicone urethane monomers are represented by Formulae IV and V:
E(*D*A*D*G)ₐ*D*A*D*E′ (IV)
or
E(*D*G*D*A)ₐ*D*G*D*E′ (V),
wherein:
D denotes an alkyl diradical, an alkyl cycloalkyl diradical, a cycloalkyl diradical, an aryl diradical or an alkylaryl diradical having 6 to 30 carbon atoms;
G denotes an alkyl diradical, a cycloalkyl diradical, an alkyl cycloalkyl diradical, an aryl diradical or an alkylaryl diradical having 1 to 40 carbon atoms and which may contain ether, thio or amine linkages in the main chain;
* denotes a urethane or ureylene linkage;
a is at least 1;
A denotes a divalent polymeric radical of Formula VI: 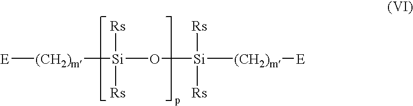
   wherein:
each R_{S} independently denotes an alkyl or fluoro-substituted alkyl group having 1 to 10 carbon atoms which may contain ether linkages between carbon atoms;
m′ is at least 1; and
p is a number which provides a moiety weight of 400 to 10,000;
each of E and E′ independently denotes a polymerizable unsaturated organic radical represented by Formula VII: 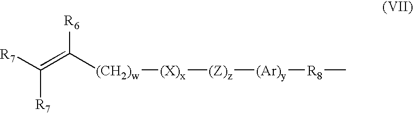
   wherein:
R₆ is hydrogen or methyl;
R₇ is hydrogen, an alkyl radical having from 1 to and including 6 carbon atoms, or a —CO—Y—R₉ radical wherein Y is —O—, —S— or —NH—;

1R₈ is a divalent alkylene radical having from 1 to and including 10 carbon atoms;
R₉ is a alkyl radical having from 1 to and including 12 carbon atoms;
X denotes —CO— or —OCO—;
Z denotes —O— or —NH—;
Ar denotes a substituted or unsubstituted aromatic radical having from 6 to and including 30 carbon atoms;
w is from 0 to and including 6; x is 0 or 1; y is 0 or 1; and z is 0 or 1.

A more specific example of a silicone-containing urethane monomer is represented by Formula VIII: 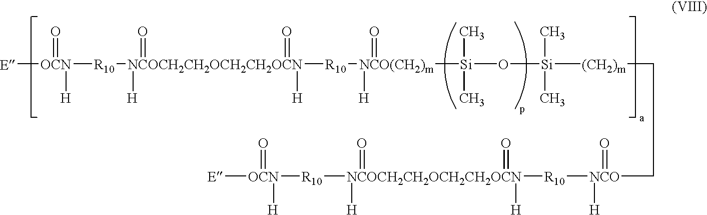
wherein m is at least 1 and is preferably 3 or 4, a is at least 1 and preferably is 1, p is a number which provides a moiety weight of 400 to 10,000 and is preferably at least 30, R₁₀ is a diradical of a diisocyanate after removal of the isocyanate group, such as the diradical of isophorone diisocyanate, and each E″ is a group represented by:

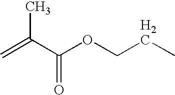

A preferred silicone hydrogel material comprises (in the bulk monomer mixture that is copolymerized) 5 to 50 percent, preferably 10 to 25, by weight of one or more silicone macromonomers, 5 to 75 percent, preferably 30 to 60 percent, by weight of one or more poly(siloxanylalkyl (meth)acrylic) monomers, and 10 to 50 percent, preferably 20 to 40 percent, by weight of a hydrophilic monomer. In general, the silicone macromonomer is a poly(organosiloxane) capped with an unsaturated group at two or more ends of the molecule. In addition to the end groups in the above structural formulas, U.S. Pat. No. 4,153,641 to Deichert et al. discloses additional unsaturated groups, including acryloxy or methacryloxy. Fumarate-containing materials such as those taught in U.S. Pat. Nos. 5,512,205; 5,449,729; and 5,310,779 to Lai are also useful substrates in accordance with the invention. Preferably, the silane macromonomer is a silicon-containing vinyl carbonate or vinyl carbamate or a polyurethane-polysiloxane having one or more hard-soft-hard blocks and end-capped with a hydrophilic monomer.

In particular regard to contact lenses, the fluorination of certain monomers used in the formation of silicone hydrogels has been indicated to reduce the accumulation of deposits on contact lenses made therefrom, as described in U.S. Pat. Nos. 4,954,587, 5,079,319 and 5,010,141. Moreover, the use of silicone-containing monomers having certain fluorinated side groups (e.g., -(CF₂)-H) have been found to improve compatibility between the hydrophilic and silicone-containing monomeric units, as described in U.S. Pat. Nos. 5,387,662 and 5,321,108.

In another aspect, a polymeric material of the present invention comprises an additional monomer selected from the group consisting of hydrophilic monomers and hydrophobic monomers.

Hydrophilic monomers can be nonionic monomers, such as 2-hydroxyethyl methacrylate (“HEMA”), 2-hydroxyethyl acrylate (“HEA”), 2-(2-ethoxyethoxy)ethyl(meth)acrylate, glyceryl(meth)acrylate, poly(ethylene glycol(meth)acrylate), tetrahydrofurfuryl(meth)acrylate, (meth)acrylamide, N,N′-dimethylmethacrylamide, N,N′-dimethylacrylamide(“DMA”), N-vinyl-2-pyrrolidone (or other N-vinyl lactams), N-vinyl acetamide, and combinations thereof. Other hydrophilic monomers can have more than one polymerizable group, such as tetraethylene glycol(meth)acrylate, triethylene glycol(meth)acrylate, tripropylene glycol(meth)acrylate, ethoxylated bisphenol-A(meth)acrylate, pentaerythritol(meth)acrylate, pentaerythritol(meth)acrylate, ditrimethylolpropane(meth)acrylate, ethoxylated trimethylolpropane(meth)acrylate, dipentaerythritol(meth)acrylate, alkoxylated glyceryl(meth)acrylate. Still further examples of hydrophilic monomers are the vinyl carbonate and vinyl carbamate monomers disclosed in U.S. Pat. No. 5,070,215, and the hydrophilic oxazolone monomers disclosed in U.S. Pat. No. 4,910,277. The contents of these patents are incorporated herein by reference. The hydrophilic monomer also can be an anionic monomer, such as 2-methacryloyloxyethylsulfonate salts. Substituted anionic hydrophilic monomers, such as from acrylic and methacrylic acid, can also be utilized wherein the substituted group can be removed by a facile chemical process. Non-limiting examples of such substituted anionic hydrophilic monomers include trimethylsilyl esters of (meth)acrylic acid, which are hydrolyzed to regenerate an anionic carboxyl group. The hydrophilic monomer also can be a cationic monomer selected from the group consisting of 3-methacrylamidopropyl-N,N,N-trimethyammonium salts, 2-methacryloyloxyethyl-N,N,N-trimethylammonium salts, and amine-containing monomers, such as 3-methacrylamidopropyl-N,N-dimethyl amine. Other suitable hydrophilic monomers will be apparent to one skilled in the art.

Non-limiting examples of hydrophobic monomers are C₁-C₂₀ alkyl and C₃-C₂₀ cycloalkyl (meth)acrylates, substituted and unsubstituted aryl(meth)acrylates (wherein the aryl group comprises 6 to 36 carbon atoms), (meth)acrylonitrile, styrene, lower alkyl styrene, lower alkyl vinyl ethers, and C₂-C₁₀ perfluoroalkyl (meth)acrylates and correspondingly partially fluorinated (meth)acrylates.

Solvents useful in the surface treatment of the medical device, such as a contact lens, include solvents that readily solubilize the polymers such as water, alcohols, lactams, amides, cyclic ethers, linear ethers, carboxylic acids, and combinations thereof. Preferred solvents include tetrahydrofuran (“THF”), acetonitrile, N,N-dimethyl formamide (“DMF”), and water. The most preferred solvent is water.

### EXAMPLE 1

### Preparation of Copolymer of Glyceryl Methacrylate and Acrylic Acid

A 250-ml three-neck flask was equipped with a stirrer and a condenser. The flask was immersed in an oil bath. Into this flask were added 100 ml of deionized water, 6.207 g (or 38.75 mmol) of glyceryl methacrylate, 1.385 g (or 19.22 mmol) of acrylic acid and 0.090 g (or 0.55 mmol) of AIBN polymerization initiator. The contents of the flask were bubbled with nitrogen vigorously for 20 minutes while under stirring, then the nitrogen flow was turned to a lower rate. The contents of the flask were heated to and kept at 70° C. under nitrogen purging for two days. The copolymer was saved as a 3% (by weight) solution in deionized water.

### EXAMPLE 2

### Lens Casting of Polyurethane-Siloxane Hydrogel Formulation

Monomer mix consisting of 14D6S5H (further described below)/TRIS/NVP(N-vinyl pyrrolidone)/DMA/HEMAVC (HEMA vinyl carbamate)/n-hexanol/Darocur™ 1173 (a photopolymerization initiator)/lMVT (1,4-bis(2-metharylamido)anthraquinone, providing a blue tint) at weight ratio of 60115/22/7/2.511/10/0.51150 ppm was made. I4D6S5H is a prepolymer having a formula of HEMA-IPDI-(PDMS5000-IPDI-DEG-IPDI)₄(PDMS5000-IPDI)₂-HEMA, wherein IPDI is isophoronediisocyanate, PDMS5000 is polydimethysiloxane having a molecular weight of 5000, and DEG is diethylene glycol. The mix was used to cast lenses using polypropylene molds. Lenses were released from the molds, extracted with isopropanol overnight, and then placed in deionized water.

### EXAMPLE 3

### Surface Treatment with Copolymer of Glyceryl Methacrylate and Acrylic Acid

An aqueous solution containing 3 weight percent of the copolymer produce in Example 1 was prepared. Lenses from Example 2 were placed in vials containing this solution and then autoclaved for one thirty-minute cycle. Five lenses from Example 2 were also autoclave in deionized water. After autoclaving, the lenses were inspected for wettability. Lenses treated with the copolymer solution were found to be more wettable and lubricious than those that were untreated or treated only with deionized water. When the lenses treated with the copolymer solution were placed in borate buffered saline, they became qualitatively even more wettable and lubricious, as judged by rubbing.

### EXAMPLE 4

### Dehydration Test

Both untreated and treated lenses were subjected to a dehydration test. Untreated and treated lenses were desalinated, then placed in deionized water before being evaluated for dehydration. Dehydration tests were carried out using a TA Instruments Q50 thermal gravimetric analyzer (“TGA”). A disc of approximately 7 mm in diameter was punched from the center of a lens. The disc was dabbed with Kimwipes® to remove any surface water and then placed on the TGA balance. The balance was enclosed in a chamber under a dry nitrogen pure (at 60 ml/minute flow rate). The sample was ramped at 500° C./minute up to 37° C. and was held isothermally. Mass loss versus time was monitored and the test was terminated when the mass loss rate (in %/minute) was less than 0.05. The dehydration rate was calculated as rate of mass loss between 60 and 20 percent per minute and reported as mg/minute. The results of the wettability and dehydration test are shown in Table 1 as the average of five measurements.

TABLE 1

| | Lens | | | | |
|---|---|---|---|---|---|
| | A | B | C | D | E |
| Water Content | 37.8 | 39.3 | 43.9 | 41.4 | 34.8 |
| (weight %) | | | | | |
| Contact Angle | 118 | 104 | 45 | 41 | 90 |
| (degrees) | | | | | |
| Time to 95% | 8.2 | 7.4 | 9.6 | 6.1 | 4.3 |
| Weight Loss | | | | | |
| Dehydration Rate | 0.601 | 0.624 | 0.557 | 0.658 | 0.644 |
| (mg/min.) | | | | | |

Notes:
A = control lens as described in Example 2, untreated
B = treated with copolymer of glyceryl methacrylate and acrylic acid (4:1 mole ratio)
C = treated with copolymer of glyceryl methacrylate and acrylic acid (2:1 mole ratio, pH = 3-4)
D = treated with solution containing only poly(acrylic acid)
E = commercial PureVison ® lens (Bausch & Lomb Incorporated, Rochester, New York)

### EXAMPLE 5

### Coating on Another Type of Lenses

Lenses manufactured with the same formulation as commercial PureVision® lenses (Bausch & Lomb Incorporated, Rochester, N.Y.) were treated with air plasma, extracted, hydrated, and autoclaved in a solution containing 0.3% (by weight) poly(glycerol methacrylate-co-acrylic acid) (2:1 molar ratio) and 1 % (by weight) poly(DMA-co-GMA) (68:32 molar ratio) in MOPS (3-{N-morpholino}propanesulfonic acid) buffer. After autoclaving, the lenses were rinsed with deionized water and saved in borate buffer saline(“BBS”). The lenses were again soaked in and rinsed with deionized water immediately before the dehydration test (same procedure as in Example 4). Table 2 shows a comparison between commercial PureVision® lenses and experimental lenses of this Example.

TABLE 2

| | | | | | | Average |
|---|---|---|---|---|---|---|
| | | | | | Dehydration | Water |
| | XPS Analysis | | | | Rate | Content |
| Lenses | C₁ₛ | N₁ₛ | O₁ₛ | Si₂ₚ | (mg/min.) | (% wt.) |
| Commercial | 65.3 | 8.0 | 19.4 | 7.0 | 0.644 | 34.8 |
| PureVision ® | (0.4) | (0.2) | (0.2) | (0.2) | | |
| This | 66.1 | 6.2 | 25.4 | 1.3 | 0.558 | 39.9 |
| Example | (0.5) | (0.4) | (0.5) | (0.4) | | |

The results show that the coated lenses were covered well with the coating polymer, as evidenced by the significant reduction in surface silicon and nitrogen. The coated lenses show significant reduction in water dehydrate rate.

In one aspect, a medical device of the present invention can have a dehydration rate of less than about 0.6. Alternatively, the dehydration rate can be less than about 0.59, or less than about 0.58, or less than about 0.57, or less than 0.56, or less than 0.5.

In another aspect, a medical device of the present invention has a contact angle of less than about 90 degrees. Alternatively, the contact angle is less than about 80 degrees, or less than about 70 degrees, or less than about 60 degrees, or less than about 50 degrees.

The present invention also provides a method for producing a medical device having improved hydrophilic surfaces. In one aspect, the method comprises: (a) providing the medical device having at least a medical-device surface functional group; (b) providing a polymer having at least a hydrophilic moiety and at least a polymer functional group capable of interacting with said at least a medical-device surface functional group; and (c) contacting the medical device with the polymer at a condition sufficient to produce the medical device having an increased surface hydrophilicity.

In another aspect, the method comprises: (a) providing the medical device having at least a medical-device surface functional group; (b) providing a linking polymer having at least a first polymer functional group capable of interacting with said at least a medical-device surface functional group and a second polymer functional group capable of interacting with at least a coating-polymer functional group of a coating polymer; (c) providing said coating-polymer having at least a hydrophilic moiety and said at least a coating polymer functional group; and (d) contacting the medical device with the linking polymer and the coating polymer at a condition sufficient to produce the medical device having an increased surface hydrophilicity. In one embodiment, the medical device is contacted with the linking polymer and the coating polymer substantially simultaneously. In another embodiment, the medical device may be contacted with the linking polymer in a medium. The coating polymer is subsequently added into the medium after an elapsed time to produce the finally treated medical device.

The step of contacting can be effected at ambient condition or under autoclave condition. The temperature for treatment can range from ambient to about 100° C., or from slightly above ambient temperature to about 80° C. The treatment time can range from about 10 seconds to about 48 hours, or from about 1 minute to about 24 hours, or from about 10 minutes to about 4 hours, or from about 10 minutes to about 2 hours.

In another aspect, the method further comprises the step of treating the surface of the medical device to increase a population of the medical-device surface functional groups before the step of contacting the medical device with the coating polymer or with the coating polymer and the linking polymer. In still another aspect, the step of treating the surface of the medical device is carried out in a plasma discharge or corona discharge environment. In yet another aspect, a gas is supplied to the discharge environment to provide the desired surface functional groups.

Medical devices having a hydrophilic coating of the present invention can be used advantageously in many medical procedures. For example, contact lenses having a hydrophilic coating and/or produced by a method of the present invention can be advantageously used to correct the vision of the natural eye.

Medical articles that are in contact with body fluid, such as a wound dressing, catheters, implants (e.g., artificial hearts or other artificial organs), can be provided with a hydrophilic coating of the present invention to inhibit bacterial attachment and growth or to reduce a deposit of lipids or proteins thereon.

In another aspect, the coating polymer of any one of the methods disclosed herein comprises units selected from the group consisting of polymerizable polyhydric alcohols, polymerizable carboxylic acids, combinations thereof, and mixtures thereof.

In a further aspect, the present invention provides a method of making a medical device that has reduced affinity for bacterial attachment. The method comprises: (a) forming the medical device comprising a polymeric material; (b) treating the medical device such that a surface thereof becomes more hydrophilic.

In one embodiment, the method comprises: (a) forming the medical device comprising a polymeric material having at least a medical-device surface functional group; (b) contacting the medical device with a coating polymer having at least a hydrophilic moiety and at least a coating-polymer functional group that is capable of interacting with said at least a medical-device surface functional group.

In another embodiment, the interaction between the coating polymer and the surface of the medical device is direct. The coating polymer also may interact indirectly with the surface of the medical device through another compound, such as a linking polymer that comprises a first functional group capable of interacting with the medical-device surface functional group and a second functional group capable of interacting with the coating-polymer functional group.

Non-limiting examples of materials for the medical device and the first and the second polymers are disclosed above.

In one embodiment, the medical device is formed by disposing precursors for the medical device material in a cavity of a mold, which cavity has the shape of the medical device, and polymerizing the precursors.

In another embodiment, a solid block of a polymeric material is first produced, then the medical device is formed from such a solid block; e.g., by shaping, cutting, lathing, machining, or a combination thereof.

In some embodiments, the medical devices produced in a method of the present invention can be contact lenses, intraocular lenses, corneal inlays, corneal rings, or keratoprotheses.

While specific embodiments of the present invention have been described in the foregoing, it will be appreciated by those skilled in the art that many equivalents, modifications, substitutions, and variations may be made thereto without departing from the spirit and scope of the invention as defined in the appended claims.

What is claimed is:

1. A polymer comprising units of a polymerizable polyhydric alcohol.

2. The polymer of claim 1, wherein the polymerizable polyhydric alcohol is other than a polymerizable poly(oxyalkylene).

3. The polymer of claim 1., further comprising units of a polymerizable carboxylic acid.

4. The polymer of claim 1, wherein the polymerizable polyhydric alcohol is selected from the group consisting of polymerizable glycerol, erythritol, xylitol, sorbitol, combinations thereof, and mixtures thereof.

5. The polymer of claim 1, wherein the polymerizable polyhydric alcohol is selected from the group consisting of glycerol(meth)acrylate, erythritol(meth)acrylate, xylitol(meth)acrylate, sorbitol(meth)acrylate, derivatives thereof, combinations thereof, and mixtures thereof.

6. The polymer of claim 3, wherein the polymerizable carboxylic acid is selected from the group consisting of (meth)acrylic acid, alkenoic acids, derivatives thereof, combinations thereof, and mixtures thereof.

7. A medical device comprising a hydrophilic coating polymer that comprises units of a polymerizable polyhydric alcohol.

8. The medical device of claim 7, wherein the hydrophilic coating polymer further comprises units of a polymerizable carboxylic acid.

9. The medical device of claim 8, wherein the polymerizable carboxylic acid is selected from the group consisting of (meth)acrylic acid, alkenoic acids, derivatives thereof, combinations thereof, and mixtures thereof.

10. The medical device of claim 8, wherein the polyhydric alcohol is selected from the group consisting of glycerol(meth)acrylate, erythritol(meth)acrylate, xylitol(meth)acrylate, sorbitol(meth)acrylate, derivatives thereof, combinations thereof, and mixtures thereof.

11. The medical device of claim 7, wherein the hydrophilic coating polymer is attached to a surface of the medical device.

12. The medical device of claim 11, wherein the hydrophilic coating polymer is attached directly to a surface of the medical device.

13. The medical device of claim 11, wherein the hydrophilic coating polymer is attached to a surface of the medical device through a linking compound, wherein the linking compound has: (a) a first functional group that interacts with a surface functional group of the medical device, and (b) a second functional group that interacts with a functional group of the hydrophilic coating polymer.

14. The medical device of claim 7, wherein the medical device has a dehydration rate of less than about 0.6 mg/minute.

15. The medical device of claim 7, wherein the medical device has a dehydration rate of less than about 0.58 mg/minute.

16. The medical device of claim 7, wherein the medical device has a contact angle of less than about 90 degrees.

17. The medical device of claim 7, wherein the medical device has a contact angle of less than about 70 degrees.

18. The medical device of claim 7, wherein the medical device has a contact angle of less than about 50 degrees.

19. The medical device of claim 15, wherein the medical device has a contact angle of less than about 90 degrees.

20. The medical device of claim 15, wherein the medical device has a contact angle of less than about 50 degrees.

21. The medical device of claim 8, wherein the coating polymer provides a plurality of charges at a physiological condition.

22. The medical device of claim 21, wherein the plurality of charges are negative charges.

23. The medical device of claim 8, wherein the coating polymer further comprises other hydrophilic monomeric units.

24. The medical device of claim 23, wherein the other hydrophilic units are selected from the group consisting of neutral monomers, cationic monomers, ampholytic monomers, and combinations thereof.

25. The medical device of claim 24, wherein the neutral monomers are selected from the group consisting of N,N-dimethylacrylamide, N-vinylpyrrolidone, (meth)acrylamide, 2-hydroxyethyl methacrylate, glyceryl methacrylate, and combinations thereof.

26. The medical device of claim 8, wherein the medical device comprises a polysiloxane.

27. The medical device of claim 7, wherein the medical device is an ophthalmic device.

28. The medical of claim 7, wherein the medical device is a contact lens.

29. A medical device comprising a coating polymer that is attached to a surface thereof, the coating polymer comprising units of a polymerizable polyhydric alcohol and units of a polymerizable carboxylic acid, wherein the medical device has a dehydration rate of less than about 0.58 mg/minute and a contact angle less than about 50 degrees.

30. A method for increasing the comfort to a user of a medical device, the method comprising contacting the medical device with a coating polymer comprising units of a polymerizable polyhydric alcohol and units of a polymerizable carboxylic acid before using the medical device.

31. The method of claim 30, further comprising the step of increasing a population of surface functional groups of the medical device before the step of contacting, wherein said surface functional groups are capable of interacting with at least a functional group of the coating polymer.

32. The method of claim 31, wherein the step of increasing the population of the surface functional groups is carried out in a plasma discharge or a corona discharge environment.

33. A method for making a medical device having an increased surface hydrophilicity, the method comprising:
(a) providing the medical device comprising a polymeric material having a plurality of medical-device surface functional groups;
(b) providing a coating polymer having at least a functional group capable of interacting with the medical-device surface functional groups; and
(c) contacting the medical device with the coating polymer at a condition sufficient to produce the medical device having an increased surface hydrophilicity.

34. The method of claim 33, further comprising the step of increasing a population of the medical-device surface functional groups before the step of contacting.

35. The method of claim 34, wherein the step of increasing the population of the medical-device surface functional groups is carried out in a plasma discharge or a corona discharge environment.

36. The method of claim 33, wherein the step of providing the medical device comprises forming the medical device.

37. The method of claim 37, wherein the step of forming comprising shaping the medical device from a polymeric material.

38. The method of claim 38, wherein the medical device is selected from the group consisting of contact lenses, intraocular lenses, corneal inlays, corneal rings, and keratoprotheses.

39. A medical device comprising a polymeric material, wherein the medical device has a dehydration rate of less than about 0.6 mg/minute.

40. The medical device of claim 39, wherein the medical device has an equilibrium water content greater than about 40 weight percent.

41. The medical device of claim 39, wherein the polymeric material comprises a hydrogel material.

42. The medical device of claim 39, wherein the polymeric material comprises a silicone hydrogel material.

43. The medical device of claim 41, wherein the polymeric material has an equilibrium water content of greater than about 40 weight percent.

44. The medical device of claim 43, wherein the medical device has a dehydration rate of less than about 0.58 mg/minute.

45. The medical device of claim 39, wherein the medical device has a contact angle of less than about 90 degrees.

46. The medical device of claim 39, wherein the medical device has a contact angle of less than about 70 degrees.

47. The medical device of claim 39, wherein the medical device has a contact angle of less than about 50 degrees.

48. The medical device of claim 40, wherein the medical device has a contact angle of less than about 70 degrees.

49. The medical device of claim 40, wherein the medical device has a contact angle of less than about 50 degrees.

50. The medical device of claim 43, wherein the medical device has a contact angle of less than about 50 degrees.

51. The medical device of claim 44, wherein the medical device has a contact angle of less than about 50 degrees.
